(19) United States
(12) Patent Application Publication
(10) Pub. No.: US 2009/0320625 A1
(43) Pub. Date: Dec. 31, 2009

(54) OSCILLATING ROTARY TOOL ATTACHMENT

(76) Inventor: Michael Rogler Kildevaeld, Yarmouthport, MA (US)

Correspondence Address: GTC Law Group LLP & Affiliates, P.O. Box 113237, Pittsburgh, PA, 15241, US

(21) Appl. No.: 12/431,444

(22) Filed: Apr. 28, 2009

Related U.S. Application Data
(60) Provisional application No. 61/048,417, filed on Apr. 28, 2008.

(51) Int. Cl. F16H 25/16

(52) U.S. Cl. 74/25

(57) ABSTRACT

The present invention provides an attachment facility for converting a rotary tool to oscillatory tool. The attachment facility may attach to a rotating drive shaft of the rotary tool and may convert the rotating motion of the drive shaft to an oscillating motion. This oscillating motion may provide oscillatory or vibration movements to the blades attached to rotary tool.

### CROSS-REFERENCE TO RELATED APPLICATIONS

This application claims the benefit of U.S. provisional application 61/048,417 filed on Apr. 28, 2008 which is hereby incorporated by reference in its entirety.

### BACKGROUND

1. Field

The invention herein disclosed generally relates to rotary tools, and specifically to attachments for converting the rotary motion of the rotary tools to an oscillatory motion.

2. Description of the Related Art

Power tools such as rotary tools and oscillatory tools are used for various machining applications such as cutting, carving, drilling, sanding, polishing, and some other applications. Various types of rotary tools such as rotating drills are manufactured by tool providers and manufacturers. Examples of some known tools include the Dremel 300-N/35 300 Series tool kit, the Dremel 1100-01 Stylus Cordless Rotary Tool, the Dremel 1130-01, the Dremel Duo 2-tool kit, and some others. Rotary tools typically have attachments, such as drill bits, screwdrivers, and the like that may be used depending on the type of application. Similarly, oscillating tools (e.g., Fein FMM250 Start Multimaster Oscillating tool kit) are known in the art that provide side-to-side, oscillating motion, such as for sanding, sawing, and some other types of applications. The oscillating tools are known to complement the rotary tools by allowing for precise, delicate work, as compared to end-to-end or rotational motion, such as provided by conventional saw blades.

Conventionally, workmen use separate tools for separate applications, particularly those applications that require two different types of motions: rotary and oscillating motions. This may become a crucial problem or constraint for workmen working in difficult conditions or environments (e.g., high altitude) that restrict the amount of weight and therefore the number of tools that can be carried by the workmen. In addition, use of separate tools for rotary and oscillating motion may not be economically viable.

### SUMMARY

A modular and handy tool that may provide both rotary and oscillating motions may also be economical to use. Such a tool may also be useful in any environmental condition. Furthermore, the tool may be easily converted to address a diverse range of tasks and shared by a number of workmen just by changing the attachments (e.g., conversion from a sanding machine to a drilling machine by removing an attachment), thereby mitigating the requirement of several separate tools for completing various machining operations.

Various embodiments of the present invention disclose a modular design of a tool that may provide both rotary and oscillatory motion.

In embodiments, an attachment for a rotary tool, such as a rotary drill, is provided. The attachment may be configured to convert a rotary tool into an oscillating tool.

The attachment may be configured to a plurality of rotary tools, cordless or plug-in that allows rotary tools (such as a ⅛″ or other sized tools) to become either oscillating or vibrating tools.

In embodiments, various additional elements may be added to the attachment facility, such that in operation the rotation of the shaft of the rotary tool creates side-to-side, oscillating movement at high speed. The oscillating attachment may be configured with additional attachment elements to allow various oscillating actions on a work piece, such as sawing, sanding, or the like, with great precision.

In an aspect of the invention, methods and systems for converting a rotational tool to an oscillating tool include a removable attachment for a rotary power tool that attaches to the rotating drive shaft of the rotary power tool and converts the rotating motion of the drive shaft to an oscillating motion and wherein the removable attachment is configured to hold an oscillating working element. In the aspect, the oscillating working element is selected from the group consisting of a cutting element and a sanding element. In the aspect, the methods and systems may further be configured with a universal threaded aftermarket device mounting screw.

### BRIEF DESCRIPTION OF THE DRAWINGS

FIG. 1 depicts an oscillating-rotary tool, in accordance with various embodiments of the present invention;

FIG. 2A, FIG. 2B, FIG. 2C, and FIG. 2D depict different structural components associated with an attachment facility, in accordance with various embodiments of the present invention;

FIG. 3A, FIG. 3B, and FIG. 3C depict different views of the oscillating-rotary tool, in accordance with various embodiments of the present invention;

FIG. 4 depicts different prospective views of the oscillating-rotary tool, in accordance with various embodiments of the present invention;

FIG. 5A, FIG. 5B, FIG. 5C, and FIG. 5D depict different views pertaining to blade mounts, in accordance with various embodiments of the present invention;

FIG. 6A, FIG. 6B, FIG. 6C, and FIG. 6D depict different views pertaining to saw blades, in accordance with various embodiments of the present invention;

FIG. 8A, FIG. 8B, FIG. 8C, FIG. 8D, and FIG. 8E depict different views pertaining to an aluminum casing, in accordance with various embodiments of the present invention;

FIG. 9A, FIG. 9B, FIG. 9C, and FIG. 9D depict different views pertaining to the aluminum cap, in accordance with various embodiments of the present invention;

FIG. 10A, FIG. 10B, FIG. 10C, and FIG. 10D depict different views pertaining to motor clamp, in accordance with various embodiments of the present invention;

FIG. 11A, FIG. 11B, FIG. 11C, and FIG. 11D depict different views pertaining to the plastic top shell, in accordance with various embodiments of the present invention;

FIG. 12A, FIG. 12B, FIG. 12C, and FIG. 12D depict different views pertaining to the plastic bottom shell, in accordance with various embodiments of the present invention;

FIG. 13A, FIG. 13B, FIG. 13C, and FIG. 13D depict different views pertaining to motor mount, in accordance with various embodiments of the present invention;

FIG. 14A, FIG. 14B, FIG. 14C, and FIG. 14D depict different views pertaining to the vertical shaft, in accordance with various embodiments of the present invention;

FIG. 15A, FIG. 15B, FIG. 15C, and FIG. 15D, depict different views pertaining to the motor shaft, in accordance with various embodiments of the present invention; and

FIG. 16A, FIG. 16B, FIG. 16C, and FIG. 16D depict different views pertaining to the swing arm, in accordance with various embodiments of the present invention.

### DETAILED DESCRIPTION

While the specification concludes with the claims defining the features of the invention that are regarded as novel, it is believed that the invention will be better understood from a consideration of the following descriptions in conjunction with the drawings/figures, in which like reference numerals are carried forward.

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The terms “a” or “an”, as used herein, are defined as one or more than one. The term “another”, as used herein, is defined as at least a second or more. The terms “including” and/or “having” as used herein, are defined as comprising (i.e. open transition). The term “coupled” or “operatively coupled” as used herein, is defined as connected, although not necessarily directly, and not necessarily mechanically.

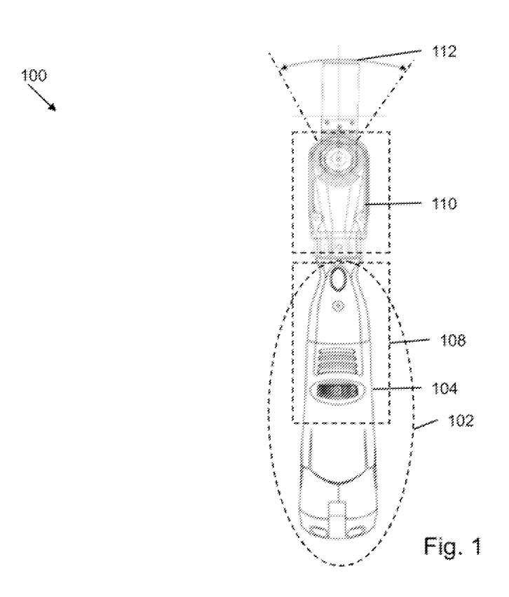

Various embodiments of the present invention may provide a rotary to oscillatory tool 100 (hereinafter oscillating-rotary tool 100) capable of providing rotary and oscillatory motions during machining operations. In FIG. 1, an exemplary oscillating-rotary tool 100 is shown. The oscillating-rotary tool 100 may include a rotary tool 102 equipped with different components such as an electric motor, thread stem, rotatable chunk, rotating drive shaft, and other components. As shown in FIG. 1, examples of these different components may include a handle 104, a motor facility 108, and the like.

The oscillating-rotary tool 100 may also include a removable attachment facility 110 and oscillating working elements 112. The removable attachment facility 110 may enable a rotary tool 102 to perform as an oscillating or vibrating tool, depending on the requirement. For example, the removable attachment facility 110 may enable the oscillating working elements 112 of a rotating drill to oscillate or vibrate.

In an exemplary scenario, a workman may require a drill machine with blades that may rotate to perform various operations on a work-piece which may include but may not be limited to drilling, cutting, shaping, and the like. For example, consider a rotary tool 102 that may be a drill machine having a drill bit for drilling holes in various materials. The workman may require a drill machine that may be easily converted to perform oscillatory or vibratory motion for operations such as cutting, carving, sawing, chiseling, filing, sanding, engraving, and the like. This may be achieved by using the removable attachment facility 110. The worker may not require any separate vibratory or oscillatory machine. In fact, the oscillating-rotary tool 100 of the present invention may provide the rotary as well as the oscillatory motion to the attached oscillating working elements 112. For example, when the removable attachment facility 110 is removed, the oscillating-rotary tool 100 may have the capability to perform rotary operations on the work-piece. In addition, the oscillating-rotary tool 100 may perform the oscillatory operations on the work-piece when the removable attachment facility 110 is attached.

In an aspect of the present invention, the removable attachment facility 110 may enable oscillating movement of the tool at high speeds. As a non-limiting example, if an independent rotary tool drive shaft rotates at 35,000 RPM, then the attachment facility 110 may facilitate 70,000 sideways oscillations per minute.

In embodiments, the oscillating removable attachment facility 110 may be configured with additional attachment elements to allow various oscillating actions on the work-piece, such as sawing, sanding, carving, chiseling, filing, engraving, and the like, with great precision. In embodiments, the removable attachment facility 110 may provide horizontal oscillations to oscillating working elements 112 of the oscillating-rotary tool 100. In other embodiments, the removable attachment facility 110 may provide vertical oscillations to the oscillating working elements 112 of the oscillating-rotary tool 100.

It may be noted that the removable attachment facility 110 has been explained in conjunction with an exemplary tool. However, those skilled in the art would appreciate that the removable attachment facility 110 may be used in conjunction with similar other tools and devices that may be used for different operations and purposes. It may also be noted that the oscillating-rotary tool 100 may be equipped with oscillating working elements 112. However, those skilled in the art may also appreciate that the oscillating working elements 112 may be of various types such as diamond blades, band saw, resaw, head saw, chain saw blades, and the like. For example, the blades may have angular teeth with varying pitches or indents.

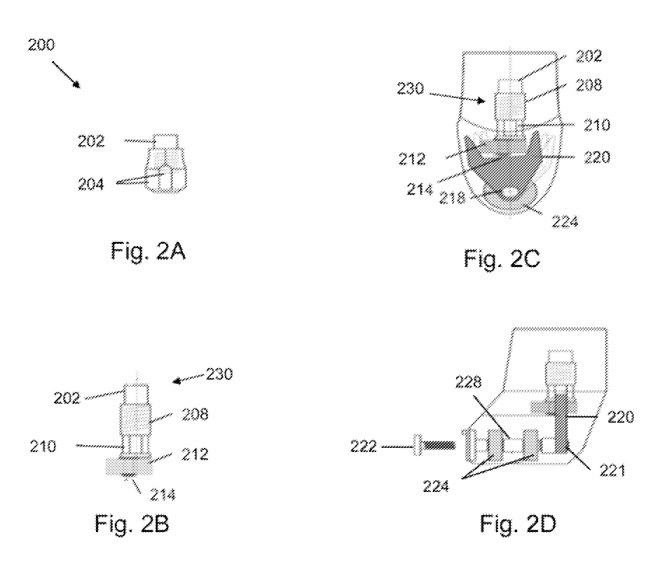

FIG. 2A, FIG. 2B, FIG. 2C, and FIG. 2D depict the various structural components associated with an embodiment of the removable attachment facility 110 that includes an offset cam bearing facility 230 for converting rotary movement to oscillating movement.

FIG. 2A shows a chuck element 204 normally attached to a rotary tool by a thread mechanism 202. In embodiments an adjustable jaw may centre a work piece in a tool such as positioning a drilling bit at the center of the chuck 204 for drilling a hole. This chuck 204 may be removed by twisting off counter-clockwise or opposite of the normal direction of rotation of the rotary tool drive shaft. In embodiments, the chuck 204 may be removed by using a small wrench (not shown in the figure). To facilitate converting rotation of a drive shaft to oscillation, chuck 204 may be replaced by a vibration attachment chuck 208, which is explained below.

As shown in FIG. 2B the removable attachment facility 110 may include an offset cam bearing facility 230 that attaches to the rotary tool in place of the chuck element 204, and may also include a vibration attachment chuck 208 with an internally threaded stem 202, which may be associated with a threaded drive shaft of a rotary tool that would normally hold the chuck element 204. An offset cam element 212 may include two ends, one of which extends further in one direction from the central axis of the offset cam bearing facility 230 than does the other end, and may provide an offset extent of rotation upon rotation of the vibration attachment chuck 208 that receives rotation from the drive shaft of a rotary tool 102. The offset bearing element 212 projects from a side of the central axis of the offset cam bearing facility 230 and transits a circle around the center of the drive shaft. The removable attachment facility 110 may also include a wrench style portion 210, and an offset post 214. The wrench style portion 210 may be used for tightening the vibration attachment chuck 208. The offset bearing element 212, optionally a ball bearing, may be attached to the vibration attachment chuck 208 through the wrench style portion 210 and may allow vibrations such as very rapid vibrations. The offset post 214 may be connected to the offset bearing 212 and may enable a cam like motion to initiate sonic vibrations. For example, the offset bearing 212 may be disk shaped and may convert the circular motion of the drive shaft into a substantially linear motion of the offset post 214.

The offset post 214 may be positioned offset from the main axis of the bearing facility 230, such that the post 214 itself transits a circle about the main axis upon rotation of the drive shaft. The offset nature of the post 214 through the bearing element 212 tends to produce a substantially linear oscillating motion of each of them upon rotation of the rotary tool drive shaft.

Various mechanisms may be used to interact with the offset bearing element 212 or the post 214, or both, in order to produce oscillating motion of a working element, such as an aftermarket attachment. In FIG. 2C a rocking element 220, also referred hereinto as a swing arm is depicted, positioned to interact with the offset bearing element 212, such that upon rotation of the offset bearing element 212, the sides of the rocking element 220 are alternatively impacted by the offset bearing element 212, causing the rocking element 220 to rock, or oscillate. The rocking element 220 may rock about a pivot point 218 that may be supported by a stabilizing bearing 224 that limits or cushions the extent of movement of the rocking element 220. The rocking element 220 may be contained in a housing.

In an alternative embodiment shown in FIG. 2D it can be seen that in one embodiment a working attachment facility may be connected to the offset cam bearing facility 230 by attaching to the post 214, such as by inserting a rod 221 onto the post 214. In alternative embodiments, the post 214 might be replaced with a channel, into which a pin or rod could be inserted. Upon movement of the offset bearing element 212 upon rotation of the offset cam bearing facility 230, the rod 221 oscillates sideways, imparting oscillating motion to a working portion of the attachment facility, including elements 224 and 228. An attachment element, such as a bit attachment screw 222 may connect a working element, such as blade, to the attachment facility 110, in which case upon rotation of the bearing facility 230, the working element oscillates.

In embodiments, various types of rocking elements 220 may be configured with the offset cam 212 to provide vibratory or oscillatory motion. For example, as shown in FIG. 2C the rocking element 220 may alter the direction of the power by 90 degrees, thereby producing vibrations. It may be noted that different rocking elements 220 may be configured with the removable attachment facility 110. Referring to FIG. 2D, the rocking element 220 may be coupled with rod 221 that may change the direction of the power by 90 degrees. The rod 221 may transit the torque to the bit attachment screw 222 through a plurality of stabilizing bearings 224. Vibrations generated by change of direction may be stabilized through a plurality of stabilizing bearings 224. It may be noted that in addition to the above stated components, the removable attachment facility 110 may also include other components which may help in performing operations on the work piece. For example, the removable attachment facility 110 may also include the rocking element 220 for the offset cam/ball bearing 212, a post 214 for sonic vibrations, a bit attachment screw 222, stabilizing bearings 224 for the post 214, and a pin 228 that may oscillate back and forth for causing vibrations.

In embodiments, the aftermarket attachments may be made up of aluminum, steel, iron, zinc, copper, and the like.

In embodiments, in addition to side to side oscillations, the oscillating working elements 112 may be configured to move up and down. For example, the blade may oscillate up and down about 0.0125 inches total (up 0.00625 inches and down 0.00625 inches) from a neural position. This extra tip and down motion may allow the oscillating working elements 112 to clear the sawdust or other debris from a work piece and may keep the oscillating working elements working well. Such an up and down movement may be facilitated by the removable attachment facility 110 as described herein, or by providing such motion in a conventional oscillating tool.

All of these components may be referred to as aftermarket installations, as these components may be changed as per the operational requirements.

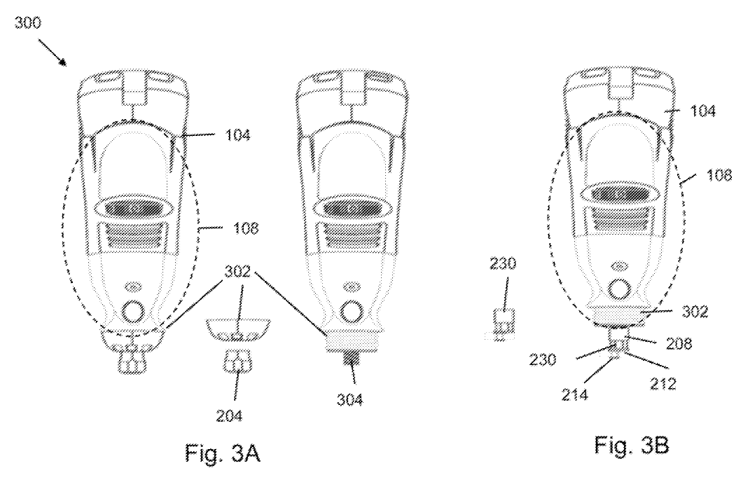

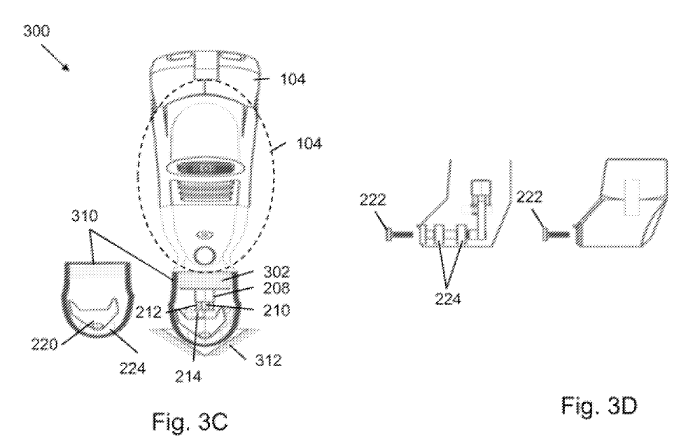

In embodiments, referring to FIG. 3A, FIG. 3B, FIG. 3C, and FIG. 3D, different views pertaining to the conversion of rotary tool 102 to oscillating-rotary tool 100 by using the removable attachment facility 110 may be provided. As shown in FIG. 3A, the conventional chuck 302 may be removed and the threaded stem 304 along with the universal threaded aftermarket device mounting screw 302 may be exposed.

In FIG. 3B, the chuck 302 may be replaced in part by the offset cam bearing facility 230, with an offset bearing element 212 and post 214 as described above in connection with FIGS. 2B, 2C and 2D. The offset cam bearing facility 230 may be screwed onto the thread of the rotary tool 102. Upon rotation of the shaft of the rotary tool, the offset bearing element 212 and post 214 transit the circumference of a circle as the offset cam bearing facility 230 rotates with the rotation of the rotary tool.

As shown in FIG. 3C, an alternate chuck 310 may be provided, configured to interoperate with the offset bearing element 212 and post 214 of the removable attachment facility 110. The alternate chuck 310 includes the rocking element 220 which rocks from side to side as the offset bearing element 212 and post 214 transit the circumference of a circle upon rotation of the rotary tool, the bearing element 212 and post 214 alternately impacting one side or the other of the rocking element 220, such that the rocking element rocks back and forth, or oscillates, in response to the current location of the offset bearing element 212 and post 214. The side-to-side rocking of the rocking element 220 thus provides oscillation back and forth (two oscillations) upon each rotation of the drive shaft of the rotary tool. The alternate chuck 310 may be adapted to screw onto the thread 302 used for attaching aftermarket installations to the rotary tool. Upon so attaching the alternate chuck 310 to the thread 302, the rocking element 220 is positioned to interact with the offset cam bearing element 212 and post 214 to provide the oscillation described above. The alternate chuck 310 may be configured to accept various forms of aftermarket working elements, including blades, sanding elements, and the like, as described herein.

As shown in FIG. 3D, in another embodiment a blade or working element may be attached to the rotary tool 102, with oscillation provided as described in connection with FIG. 2D. Thus, the rotary tool may now operate as an oscillatory tool and it may be referred to as the oscillating-rotary tool 100. In the above embodiments, the removable attachment facility 110 may provide vibratory or the oscillatory motion to the oscillating working elements 112 or other aftermarket attachments.

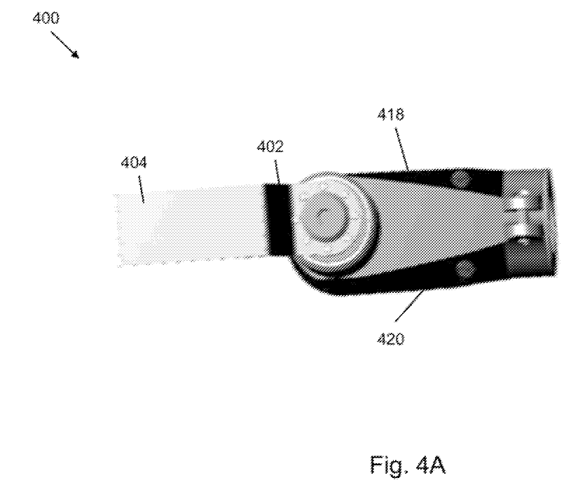

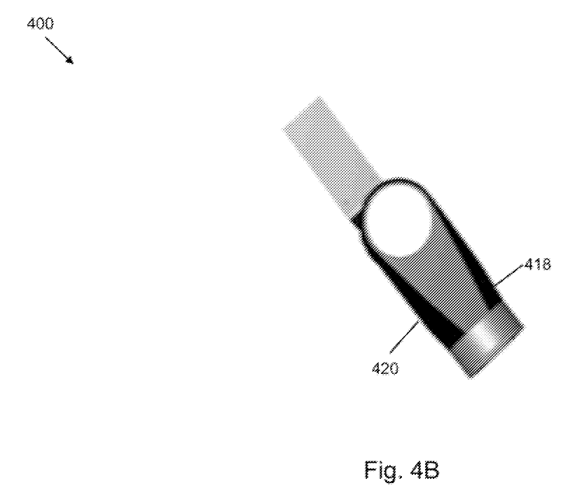

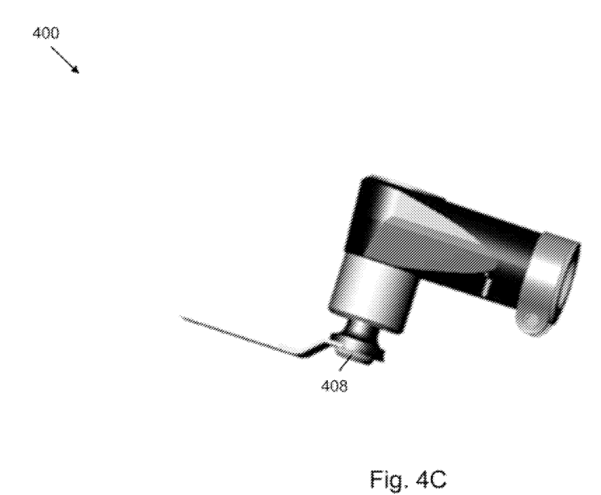

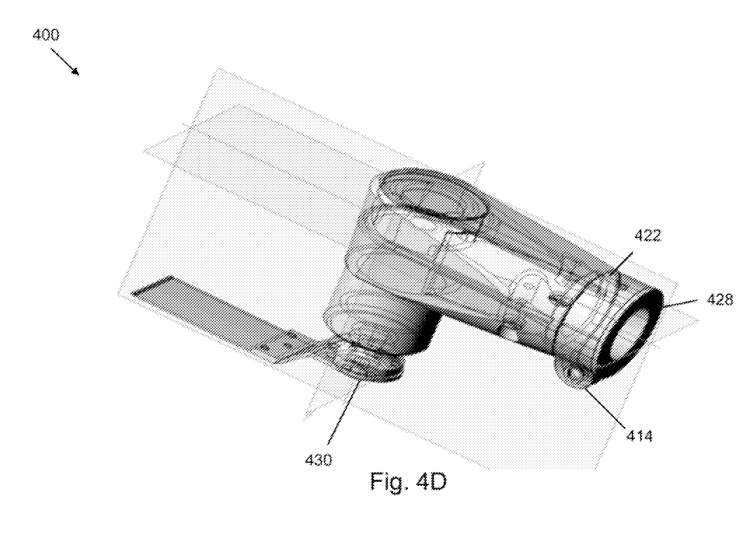

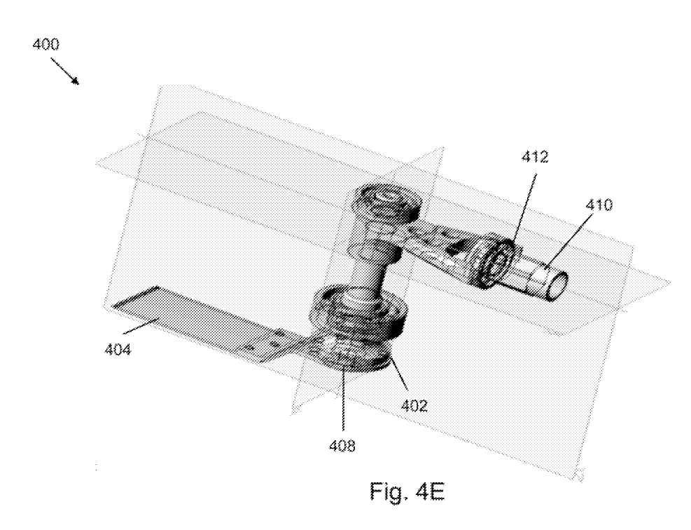

In embodiments, different views of the oscillating-rotary tool 100 may be shown in FIG. 4A, FIG. 4B, FIG. 4C, FIG. 4D, and FIG. 4E. FIG. 4A, FIG. 4B, FIG. 4C, FIG. 4D, and FIG. 4E and may be shown to have blade mountings 402, saw blade attachment 404, blade screw 408, aluminum casing 410, aluminum cap 412, motor clamp 414, plastic top shell 418, plastic bottom shell 420, motor attachment 422, vertical shaft 424, motor shaft housing 428, swing arm attachment 430, and the like. The description and different views corresponding to each of the above stated components may be provided below.

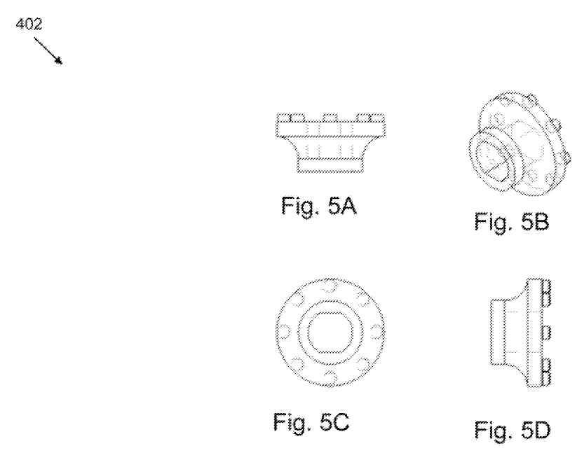

In embodiments, referring to FIG. 5A, FIG. 5B, FIG. 5C, and FIG. 5D, different views pertaining to blade mounts 402 may be shown. The blade mounts 402 may secure blades 404 to the removable attachment facility 110, by using 8 small pins around the blades 404. The blade mount 402 may be positioned to 0, 45, 90, 135, 180, 225, 270, degrees so that every 45 degrees in a full rotation may allow blades 404 to be mounted upside down.

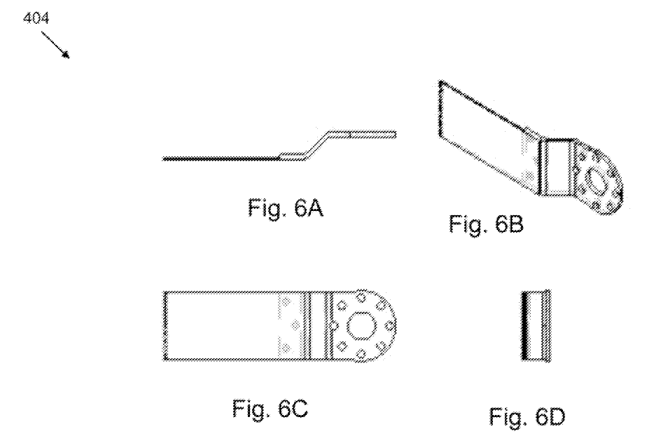

In embodiments, referring to FIG. 6A, FIG. 6B, FIG. 6C, and FIG. 6D, different views pertaining to saw blades 404 may be provided. The saw blades 404 may be attached to the removable attachment facility 110 and may rotate back and forth along the vertical shaft 424 1.5 degrees each side (left and right) to provide the oscillating cut, sand, removal action, and the like.

In embodiments, referring to FIG. 7A, FIG. 7B, FIG. 7C, and FIG. 7D, different views pertaining to blade screws 408 may be provided. The blade screws 408 may fasten the blade 404 to blade mount 402. The blade screws 408 may have a wide head which may enable it to come close to the 8 small pins holding the blade position.

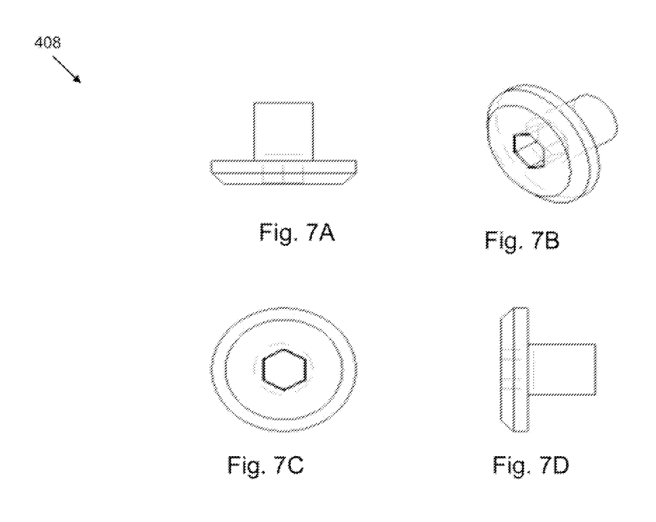

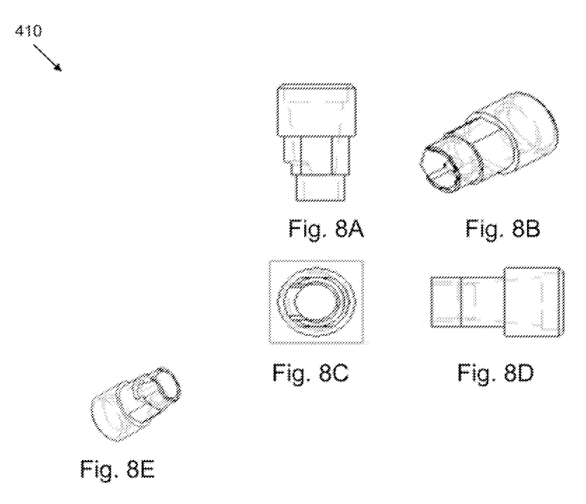

In embodiments, referring to FIG. 8A, FIG. 8B, FIG. 8C, and FIG. 8D, and FIG. 8E, different views pertaining to an aluminum casing 410 may be provided. The aluminum casing 410 may stabilize the vertical shaft 424 by holding/securing the top and bottom ball bearings 212.

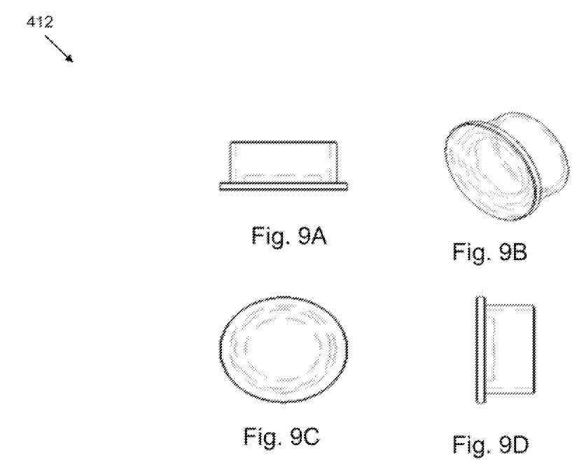

In embodiments, referring to FIG. 9A, FIG. 9B, FIG. 9C, and FIG. 9D, different views pertaining to the aluminum cap 412 may be provided. The aluminum cap 412 may be a part of the aluminum casing 410. This cap 412 may stabilize top vertical shaft ball bearing by enclosing the top of the aluminum casing 410.

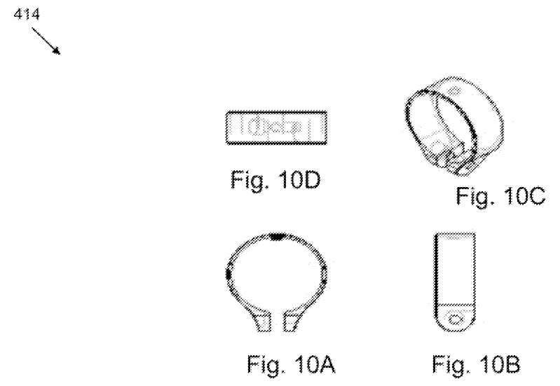

In embodiments, referring to FIG. 10A, FIG. 10B, FIG. 10C, and FIG. 10D, different views pertaining to motor clamp 414 may be provided. The motor clamp 414 may secure the casing to the motor mount 422. The plastic top and bottom casing may have a slice in the casing to allow the plastic to contract when the motor clamp 414 is tightened over the plastic casing.

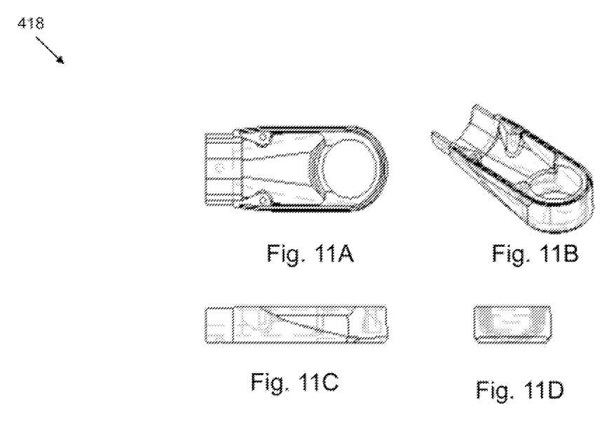

In embodiments, referring to FIG. 11A, FIG. 11B, FIG. 11C, and FIG. 11D, different views pertaining to the plastic top shell 418 may be provided. The plastic top shell 418 may be a part of the plastic casing and may provide torsion strength to casing by placing scam horizontal with an integrated scam to enclose top and bottom casing. The plastic top shell 418 may also attach to motor mount with an octagon joint to position head of the attachment in most positions firmly without spinning. The plastic casing may have a radius wall which may inclosing/stabilizing the aluminum casing 410.

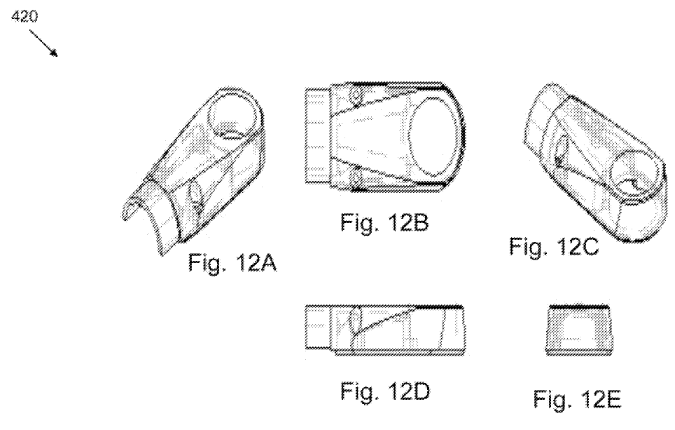

In embodiments, referring to FIG. 12A, FIG. 12B, FIG. 12C, and FIG. 12D, different views pertaining to the plastic bottom shell 420 may be provided. The plastic bottom shell 420 may be a part of the plastic casing and may provide torsion strength to casing by placing seam horizontal with an integrated seam to enclose top and bottom casing. The plastic bottom shell 420 may also attach to motor mount 422 with an octagon joint to position head of the attachment in most positions firmly without spinning. The plastic casing may have a radius wall which may inclosing/stabilizing the aluminum casing 410.

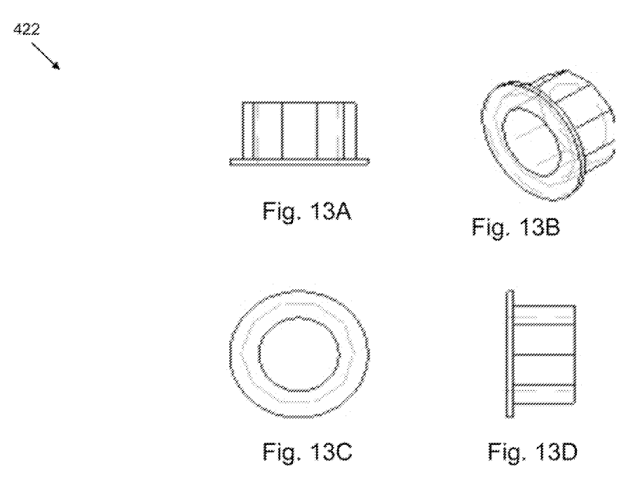

In embodiments, referring to FIG. 13A, FIG. 13B, FIG. 13C, and FIG. 13D, different views pertaining to motor mount 422 may be provided.

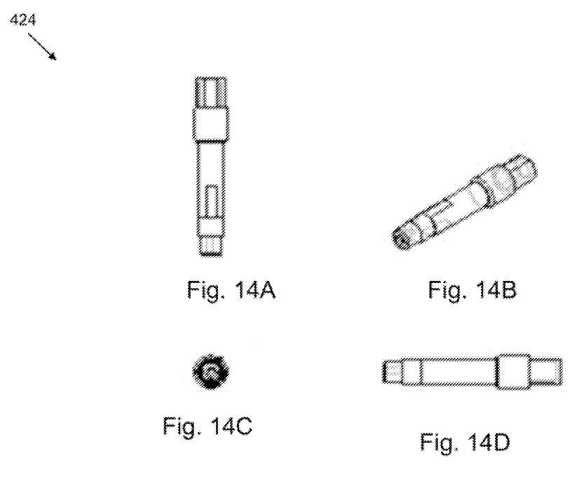

In embodiments, referring to FIG. 14A, FIG. 14B, FIG. 14C, and FIG. 14D, different views pertaining to the vertical shaft 424 may be provided. The vertical shaft 424 may oscillate 3 degrees, may hold the rocking element or swing arm 430 and the motor mount 422 may be aligned to each other. A top and bottom ball bearing may allow the vertical shaft 424 to rotate 1.5 degrees left and 1.5 degrees.

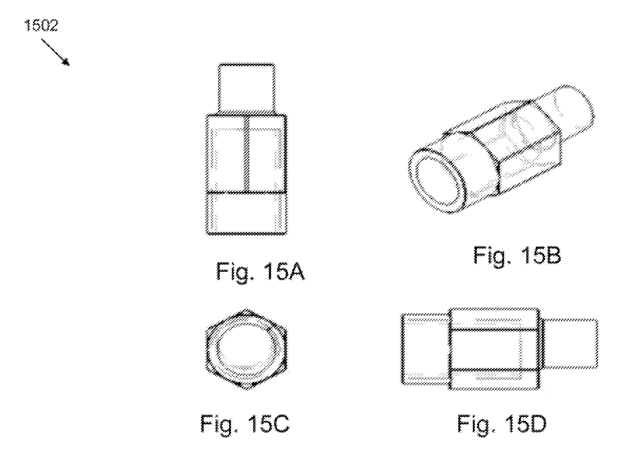

In embodiments, referring to FIG. 15A. FIG. 15B, FIG. 15C, and FIG. 15D, different views pertaining to the alternate embodiments of a vibration attachment chuck 1502 may be provided. The chuck 1502 may transfer a rotary tool rotational action to the removable attachment facility 110. The end of the chuck 1502 that mounts to the rotary tool drive shaft may be threaded.

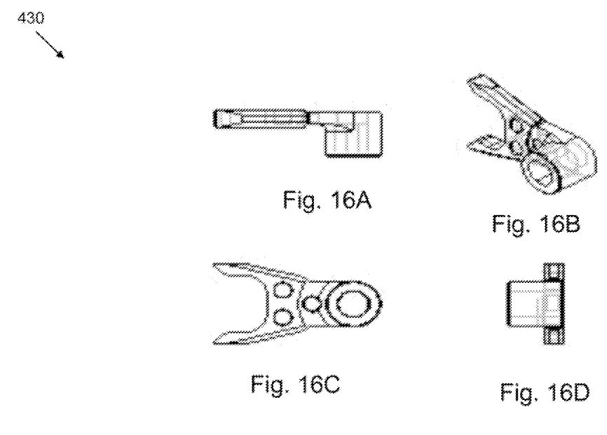

In embodiments, referring to FIG. 16A, FIG. 16B, FIG. 16C, and FIG. 16D, different views pertaining to the swing arm 430 may be provided. The swing arm 430 may attach to the vertical shaft 424. The swing arm 430 may follow the oscillating motion described above for the rocking element 220. The swing arm 430 may swing back and forth 1.5 degrees in each direction.

While the invention has been disclosed in connection with the preferred embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law.

All documents referenced herein are hereby incorporated by reference.

What is claimed is:

1. A removable attachment for a rotary power tool, wherein the removable attachment attaches to the rotating drive shaft of the rotary power tool and converts the rotating motion of the drive shaft to an oscillating motion and wherein the removable attachment is configured to hold an oscillating working element.

2. An apparatus of claim 1, wherein the oscillating working element is selected from the group consisting of a cutting element and a sanding element.

3. An apparatus of claim 1, wherein the attachment for a rotary power tool is further configured with a universal threaded aftermarket device mounting screw.
